(19) United States
(12) Patent Application Publication
(10) Pub. No.: US 2025/0106772 A1
(43) Pub. Date: Mar. 27, 2025

(54) MONITORING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/846,751

(22) PCT Filed: Mar. 16, 2022
(86) PCT No.: PCT/CN2022/081131

§ 371 Date: Sep. 13, 2024

(51) Int. Cl. H04W 52/02; H04L 5/00; H04W 36/00

(52) U.S. Cl. CPC H04W 52/0235; H04L 5/0005; H04W 36/0085

(57) ABSTRACT

A monitoring method includes: monitoring a wake-up signal on the basis of a first transceiver of a UE, wherein the wake-up signal is used for waking up a second transceiver of the UE.

### CROSS-REFERENCE TO RELATED APPLICATIONS

This application is a National Stage of International Application No. PCT/CN2022/081131, filed on Mar. 16, 2022, which is incorporated by reference herein in its entirety for all purposes.

### TECHNICAL FIELD

This disclosure relates to but is not limited to the field of communication technology, and in particular, to a monitoring method, a monitoring apparatus, a communication device and a storage medium.

### BACKGROUND

Currently, when UE (User Equipment) in a non-connected state monitors the paging message, it usually performs the monitoring in the DRX (Discontinuous Reception) cycle. Generally, when the UE detects a wakeup signal, it means that the UE needs to monitor the PDCCH (Physical Downlink Control Channel). If no wakeup signal is received, the PDCCH monitoring is skipped. Since no matter what kind of wakeup signal is concerned, the terminal needs to detect the wakeup signal, it is desired to introduce a separate transceiver (ultra-low power wake-up receiver) to receive the wakeup signal. However, after introducing the separate transceiver for the LIE, there is no solution yet for the working state of the terminal.

### SUMMARY

Embodiments of this disclosure provide a monitoring method, a monitoring apparatus, a communication device and a storage medium.

According to a first aspect of this disclosure, a monitoring method performed by a UE is provided and includes:
monitoring a wakeup signal based on a first transceiver of the UE, where the wakeup signal is used to wake up a second transceiver of the UE.

According to a second aspect of this disclosure, a monitoring method performed by a network device is provided and includes:
sending a wakeup signal, where the wakeup signal is used to, after being received by a UE based on a first transceiver, wake up a second transceiver of the UE.

According to a third aspect of this disclosure, a communication device is provided. The communication device includes:
a processor; and
a memory configured to store executable instructions of the processor,
where the processor is configured to, upon running the executable instructions, implement the monitoring method according to any embodiment of this disclosure.

It should be understood that the above general description and the following detailed description are only exemplary and explanatory, and do not limit the embodiments of this disclosure.

### BRIEF DESCRIPTION OF THE DRAWINGS

FIG. 1 is a schematic structural diagram of a wireless communication system.

FIG. 2 is a flow chart of a monitoring method according to an exemplary embodiment.

FIG. 3 is a flow chart of a monitoring method according to an exemplary embodiment.

FIG. 4 is a flow chart of a monitoring method according to an exemplary embodiment.

FIG. 5 is a flow chart of a monitoring method according to an exemplary embodiment.

FIG. 6 is a flow chart of a monitoring method according to an exemplary embodiment.

FIG. 7 is a flow chart of a monitoring method according to an exemplary embodiment.

FIG. 8 is a block diagram of a monitoring apparatus according to an exemplary embodiment.

FIG. 9 is a block diagram of a monitoring apparatus according to an exemplary embodiment.

FIG. 10 is a block diagram of a UE according to an exemplary embodiment.

FIG. 11 is a block diagram of a base station according to an exemplary embodiment

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of this disclosure. Rather, they are merely examples of apparatuses and methods consistent with some aspects of embodiments of this disclosure as detailed in the appended claims.

The terminology used in the embodiments of this disclosure is for the purpose of describing specific embodiments only and is not intended to limit the embodiments of this disclosure. As used in the embodiments of this disclosure and the appended claims, the singular forms “a”. “an” and “the” are intended to include the plural forms as well, unless the context clearly dictates otherwise. It will also be understood that the term “and/or” as used herein refers to and includes any and all possible combinations of one or more of the associated listed items.

It should be understood that although the terms “first”, “second”, “third”, etc. may be used to describe various information in the embodiments of this disclosure, the information should not be limited to these terms. These terms are only used to distinguish information of the same type from each other. For example, without departing from the scope of the embodiments of this disclosure, the first information may also be called second information, and similarly, the second information may also be called first information. Depending on the context, the word “if” as used herein may be interpreted as “when” or “while” or “in response to determining that . . . ”

Referring to FIG. 1, which shows a schematic structural diagram of a wireless communication system according to an embodiment of this disclosure. As shown in FIG. 1, the wireless communication system is a communication system based on cellular mobile communication technology, and the wireless communication system may include: several UEs 110 and several base stations 120.

In some embodiments, UE 110 may be a device that provides voice and/or data connectivity to the user. UE 110 can communicate with one or more core networks via a radio access network (RAN), and UE 110 can be an Internet of things (IoT) UE, such as a sensor device, a mobile phone (or called “cellular” phone), and a computer with an IoT UE. For example, it may be a fixed, portable, pocket, hand-held, computer built-in, or vehicle-mounted device, such as station (STA), subscriber unit, subscriber station, mobile station, mobile, remote station, access point, remote terminal, access terminal. user terminal, user agent, user device, or user equipment. Alternatively, UE 110 may also be equipment of an unmanned aerial vehicle. Alternatively, UE 110 may also be a vehicle-mounted device, for example, a trip computer with a wireless communication function, or a wireless user device connected externally to the trip computer. Alternatively, UE 110 may also be a roadside device, for example, a street lamp, a signal lamp, or other roadside devices with a wireless communication function.

The base station 120 may be a network side device in the wireless communication system. In some embodiments, the wireless communication system may be the 4th generation mobile communication (4G) system, also known as the Long Term Evolution (LTE) system. Alternatively, the wireless communication system may also be the 5G system. also known as new air interface system or 5G NR system. Alternatively, the wireless communication system may also be a next-generation system of the 5G system. In some embodiments, the access network in the 5G system can be called NG-RAN (New Generation-Radio Access Network).

In some embodiments, the base station 12 may be an evolved node-B (eNB) adopted in the 4G system. Alternatively, the base station 12 may also be a gNB adopting a centralization-distributed architecture in the 5G system. When the base station 12 adopts the centralization-distributed architecture, it generally includes a central unit (CU) and at least two distributed units (DUs). The CU is provided with a packet data convergence protocol (PDCP) layer, a radio link layer (RLC) protocol layer, a media access control (MAC) layer protocol stack; and the DU is provided with a physical (PHY) layer protocol stack. Embodiments of this disclosure do not limit the specific implementation of the base station 120.

A wireless connection may be established between the base station 120 and UE 110 through a wireless air interface. In different embodiments, the wireless air interface is a wireless air interface based on the 4G standard; alternatively, the wireless air interface is a wireless air interface based on the SG standard, for example, a new air interface; alternatively, the wireless air interface may also be a wireless air interface based on a technical standard of a next-generation mobile communication network based on SG.

In some embodiments, an E2E (End to End) connection may also be established between UEs 110, for example, in the scenarios including V2V (vehicle to vehicle) communication, V2I (vehicle to Infrastructure) communication and V2P (vehicle to pedestrian) communication in V2X (vehicle to everything) communication.

Here, the forgoing user equipment can be considered as the terminal device of the following embodiments.

In some embodiments, the forgoing wireless communication system may further include a network management device 130.

Several base stations 120 are connected to the network management device 130 respectively. The network management device 130 may be a core network device in the wireless communication system. For example, the network management device 130 may be a MME (Mobility Management Entity) in an EPC (Evolved Packet Core) network. Alternatively, the network management device may also be other core network devices, such as SGW (Serving Gate Way), PGW (Public Data Network Gate Way), PCRF (Policy and Charging Rules Function), HSS (Home Subscriber Server), or the like. Embodiments of this disclosure do not limit the implementation form of the network management device 130.

In order to facilitate understanding by those skilled in the art, the embodiments of this disclosure enumerate multiple implementations to clearly describe the technical solutions according to some embodiments of this disclosure. Those skilled in the art can understand that the multiple embodiments provided in this disclosure can be implemented alone or in combination with the methods according to other embodiments of this disclosure. They can also be implemented alone or in combination with some methods in related art. Embodiments of this disclosure do not limit this.

In order to better understand the technical solution described in any embodiment of this disclosure, a partial description of the power saving signal in related art is given as follows.

As an example, in the power saving project of R16, a power saving signal is introduced for UE in the connected sate. The power saving signal may be a wakeup signal or a DCI (downlink control information) for power saving (DCP). For example, if the UE detects the wakeup signal, it is determined that the UE needs to monitor (or referred to as listen to) the PDCCH; if the UE detects no wakeup signal, the PDCCH monitoring is skipped.

As another example, in the power saving project of R17, a power saving signal is introduced for UE in the idle state. The power saving signal may be a PEI (paging advance indication). Here, the PEI can be configured before the PO (paging occasion). For example, if the UE detects the power saving signal, it needs to monitor the paging DCI, if the UE detects no power saving signal, it skips monitoring the paging DCI.

As yet another example, enhancements are made to connected UEs in R17, and a PDCCH skipping mechanism is introduced. For example, if the UE detects a DCI carrying information indicating the PDCCH skipping mechanism, it determines to skip monitoring for a preset duration or perform switching of search space group.

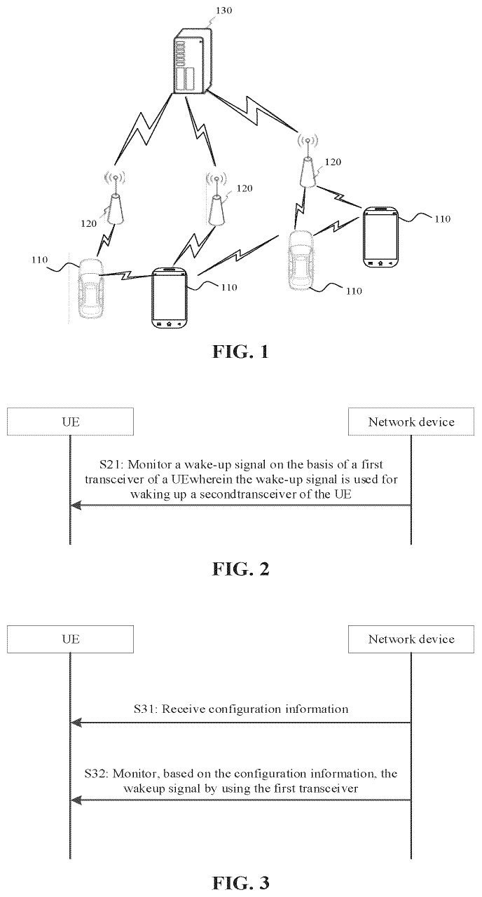

As shown in FIG. 2, some embodiments of this disclosure provide a monitoring method, which is performed by the UE and includes followings.

In step S21, a first transceiver of the UE monitors a wakeup signal, where the wakeup signal is used to wake up a second transceiver of the UE.

In some embodiments, the UE may be various mobile terminals or fixed terminals. For example, the UE may be, but is not limited to, a mobile phone, a computer, a server, a wearable device, a game control platform, a multimedia device, or the like,

This step S21 may be implemented as that the UE in the RRC (Radio Resource Control) non-connected state monitors the wakeup signal by using the first transceiver. Here, the RRC non-connected state includes: RRC idle state and/or RRC inactive state. Here, the RRC non-connected state may also be a newly defined RRC non-connected state. For example. the newly defined RRC non-connected state is the RRC ultra-unconnected state, where the RRC ultra-unconnected state includes: RRC ultra-idle state (RRC ultra-IDLE) and/or RRC ultra-inactive state (RRC ultra-INACTIVE).

This step S21 may be implemented as that the first transceiver of the UE monitors the wakeup signal sent by a network device. Here, the network device may be an access network device or a core network device, where the access network device may be, but is not limited to, a base station; and the core network device may be, but is not limited to, various network functions or entities that implement network functions. Here, the base station may be, but is not limited to, at least one of the following: a 3G base station, a 4G base station, a 5G base station and other evolved base stations. If the wakeup signal is sent by the core network device, the core network device sends the wakeup signal to the base station, and the base station forwards the wakeup signal to the UE.

Here, the awakened second transceiver is configured to monitor a paging message. Alternatively, the awakened second transceiver can also be configured to perform any implementable operation including, for example, monitoring system message, performing cell selection or reselection, and/or performing cell measurement, and the like.

Here, a power consumption of the first transceiver is less than a power consumption of the second transceiver. When referring to that the power consumption of the first transceiver is less than the power consumption of the second transceiver, it may be as follows: a power consumed by the first transceiver for receiving and/or sending information is less than a power consumed by the second transceiver for receiving and/or sending information. For example, less power is consumed by the first transceiver decoding each signal than the second transceiver decoding the same signal.

In some embodiments, the UE includes the first transceiver and the second transceiver, where the power consumption of the first transceiver is less than that of the second transceiver. Here, the structure of the first transceiver is very simpler compared to the structure of the second transceiver. The second transceiver may be the main transceiver of the UE, while the first transceiver is an independent transceiver (ultra-low power wake-up receiver) introduced for the UE.

In some embodiments, the first transceiver has the functions of receiving and sending, and the second transceiver has the functions of receiving and sending.

In some embodiments, the first transceiver may also be: a first receiver; and/or the second transceiver may be: a second receiver. Here, the first receiver has the function of receiving, and/or the second receiver has the function of receiving.

In some other embodiments, the first transceiver is a secondary transceiver, and the second transceiver is a primary transceiver. Here, the secondary transceiver is configured to assist the primary transceiver in receiving and/or sending information.

Here, the wakeup signal is used to trigger exiting a working mode of monitoring the wakeup signal based on the first transceiver.

In some embodiments, the wakeup signal may be any power saving signal. For example, the wakeup signal may be the PEI signal or the DCP signal mentioned above: or the wakeup signal may be a signal with fewer bits than the PEI signal or the DCP signal, as long as the wakeup signal can be used to wake up the second transceiver.

In some embodiments, the wakeup signal may be a signal less than or equal to a first power. For example, the wakeup signal may be a low-power wakeup signal.

For example, the wakeup signal may be a preset bit signal such as “00”, “001”, “00111” or the like. The wakeup signal may be used to wake up the second transceiver to monitor the paging message.

In an embodiment of this disclosure, the UE may monitor the wakeup signal based on the first transceiver of the UE, where the wakeup signal is used to wake up the second transceiver of the UE, In this way, after introducing the first transceiver with relatively low power consumption for the UE, the first transceiver with relatively low power consumption can monitor the wakeup signal before waking up the second transceiver with relatively high power consumption, without having the second transceiver with relatively high power consumption to monitor the wakeup signal, thereby saving the power consumption and battery life of the UE.

In some embodiments of this disclosure, the wakeup signal is used to wake up the second transceivers of at least some UEs within a cell. Exemplarily, the network device sends the wakeup signal to one UE or multiple UEs within a preset cell, and each UE that receives the wakeup signal can wake up the second transceiver based on the wakeup signal.

In this way, some or all UEs within a cell can wake up the second transceivers based on the received wakeup signal, thereby saving the power consumption and battery life for all UEs in the cell. Moreover, the network device can broadcast or multicast the wakeup signal, thereby further saving the power consumption and battery life of the network device.

In some embodiments of this disclosure, when the UE monitors the wakeup signal based on the first transceiver of the UE, the second transceiver of the UE is in a first off state. Here, the first off state may be a fully-off state.

In some embodiments, when the first transceiver of the UE monitors the wakeup signal, the second transceiver of the UE is in a first off state, where the second transceiver in the first off state is configured to stop all behaviors of AS (Access Stratum).

Exemplarily, the second transceiver in the first off state is configured to select, but is not limited to, at least one of the following:
not performing cell selection or reselection;
not performing reselection of PLMN (public land mobile network);
not performing monitoring of paging;
not performing monitoring of system message;
not performing cell measurement.

Here, the system message may be any kind of system message. For example, the system message may be SIB X, where X is an integer greater than or equal to 0. The SIB X may be SIB 1, SIB2, SIB3, or the like.

Here, when referring to that the second transceiver does not perform cell measurement. it includes not performing measurement on the cell where the UE is located and/or not performing measurement on neighboring cells of the cell where the UE is located. Here, the cell where the UE is located is the serving cell of the UE.

In some embodiments of this disclosure, when the UE monitors the wakeup signal based on the first transceiver, the second transceiver is in a fully-off state, so that the UE stops all bebaviors of AS. For example, it may include but is not limited to at least one operation of the second transceiver including: stopping cell selection or reselection, stopping PLMN reselection, stopping monitoring of paging message, stopping monitoring of system message, and stopping cell measurement. In this way, according to some embodiments of this disclosure. the behavior of the second transceiver is defined after introducing the first transceiver at the UE to monitor the paging message. Moreover, according to some embodiments of this disclosure, the second transceiver does not need to perform behavior of AS until detecting the wakeup signal by the first transceiver, thereby saving the power consumption and battery life of the UE.

In some other embodiments of this disclosure, when the UE monitors the wakeup signal based on the first transceiver of the UE, the second transceiver of the UE is in a second off state. Here, the second off state may be a partially-off state.

In some embodiments, when the first transceiver of the UE monitors the wakeup signal, the second transceiver of the UE is in the second off state, where the second transceiver in the second off state is configured to maintain part of the behaviors of AS.

Exemplarily, the second transceiver in the second off state is configured to select at least one of the following:
performing measurement relaxation on a neighboring cell and/or a cell where the UE is located;
stopping measurement on the neighboring cell and/or the cell where the UE is located.

Here, when referring to that the second transceiver performs relaxation on the measurement of a cell, it may be implemented as that the second transceiver performs relaxation on the reference signal measurement of the cell where the UE is located. When referring to that the second transceiver performs relaxation on the measurement of a neighboring cell(s) of the cell, it may be implemented as that the second transceiver performs relaxation on the reference signal measurement(s) of the neighboring cell(s) of the cell where the UE is located. The cell where the UE is located is the serving cell of the UE. The neighboring cell includes a neighboring cell(s) of the serving cell where the UE is located. Here, the UE may perform relaxed measurement of the serving cell and/or the neighboring cell(s) based on the second transceiver, thereby achieving the effect of power saving.

In some embodiments of this disclosure, when the UE monitors the wakeup signal based on the first transceiver, the second transceiver is in the partially-off state, so that the UE maintains part of the behaviors of AS. For example, it may include but not limited to at least one operation of the second transceiver including performing a relaxed measurement on the cell where the UE is located, performing a relaxed measurement(s) on the neighboring cell(s), and stopping measurement on the neighboring cell(s) and/or the cell where the UE is located. In this way, according to some embodiments of this disclosure, the behavior of the second transceiver is defined after introducing the first transceiver at the UE to monitor the paging message. According to some embodiments of this disclosure, only some behaviors of AS can be maintained by the second transceiver before the wakeup signal is detected by the first transceiver, thereby also saving the power consumption and battery life of the UE.

It should be noted, those skilled in the art can understand that the methods according to some embodiments of this disclosure may be implemented alone or together with some methods according to other embodiments of this disclosure or some methods in related art.

In some embodiments, the method includes: receiving configuration information.

Step S21 includes: monitoring, based on the configuration information, the wakeup signal by using the first transceiver.

As shown in FIG. 3, some embodiments of this disclosure provide a monitoring method, which is performed by the UE and includes followings.

In step S31, configuration information is received.

In step S32, the wakeup signal is monitored by using the first transceiver of the UE based on the configuration information.

In some embodiments of this disclosure, the first transceiver is the first transceiver in step S21, and the wakeup signal is the wakeup signal in step S21.

The configuration information includes but is not limited to at least one of the following:
time-frequency domain information, used to indicate a time-frequency domain position for monitoring the wakeup signal;
codeword information, used to indicate scrambling information for monitoring the wakeup signal;
period information, used to indicate a period for monitoring the wakeup signal;
offset, used to indicate a time offset of a sending time of the wakeup signal relative to a starting time of the period;
times information, used to indicate a number of times the wakeup signal is sent;
monitoring mode information, used to indicate a monitoring mode for monitoring the wakeup signal, where the monitoring mode includes a periodic monitoring mode and/or a continuous monitoring mode.

Step S31 may include receiving the configuration information sent by the network device. For example, the UE may receive a notification message sent by the network device, where the notification message carries the configuration information. In some embodiments, the notification message may be a system message.

Here, the UE can receive the configuration information in any implementable manner. For example, the UE receives the configuration information when it is in the RRC connected state, or the UE in the RRC non-connected state receives the configuration information during an activated DRX duration of the DRX cycle.

In some embodiments, the period indicated in the period information may be a DRX cycle and/or an extended DRX cycle, where the extended DRX cycle may be a preset multiple of the DRX cycle.

In some other embodiments, the period indicated in the period information may be greater than or equal to a first duration. For example, the first duration may be 5.12 seconds, 10.24 seconds, or the like.

In some embodiments, the number of sending times indicated in the times information refers to the number of times the wakeup signal is repeatedly sent. For example, the times information is used to indicate that the number of times the wakeup signal is repeatedly sent within a preset time interval is N, where N is an integer greater than 1. In this way, by repeatedly sending the wakeup signal, the probability of the UE detecting the wakeup signal can be increased.

In some embodiments, the periodic monitoring mode may be a mode of monitoring at preset time intervals.

Some embodiments of this disclosure provide a monitoring method, which is performed by the UE and includes: monitoring the wakeup signal in the periodic monitoring mode based on the first transceiver. For example, the first transceiver of the UE may monitor the wakeup signal on the PDCCH channel every 5 seconds. In this way, according to some embodiments of this disclosure, the wakeup signal needs not to be always monitored through the first transceiver, and the first transceiver can monitor the wakeup signal at preset time intervals, thereby further saving the power consumption and battery life of the UE.

In some embodiments, the continuous monitoring mode may be a mode of continuous monitoring.

Some embodiments of this disclosure provide a monitoring method, which is performed by the UE and includes: monitoring the wakeup signal in the continuous monitoring mode based on the first transceiver. For example, the first transceiver of the UE continuously monitors the wakeup signal on the PDCCH. In this way, according to some embodiments of this disclosure, the wakeup signal can be continuously monitored, thereby reducing the probability of missing the wakeup signal and increasing the probability of monitoring the wakeup signal.

In some embodiments of this disclosure, the continuous monitoring mode may also be performed at a preset time interval, and the preset time interval in the continuous monitoring mode is smaller than the preset time interval in the periodic monitoring mode. For example, the periodic monitoring mode is a mode of monitoring at a first preset time interval, and the continuous monitoring mode is a mode of monitoring at a second preset time interval. where the first preset time interval is greater than the second preset time interval.

In some embodiments of this disclosure, the UE may monitor, using the first transceiver, the wakeup signal based on the configuration information sent by the network device. In this way, according to some embodiments of this disclosure, the wakeup signal can be monitored through the configuration of the network device, thereby facilitating the scheduling of resources by the network device.

In some embodiments, step S21 includes: monitoring the wakeup signal by using the first transceiver based on a pre-agreed protocol.

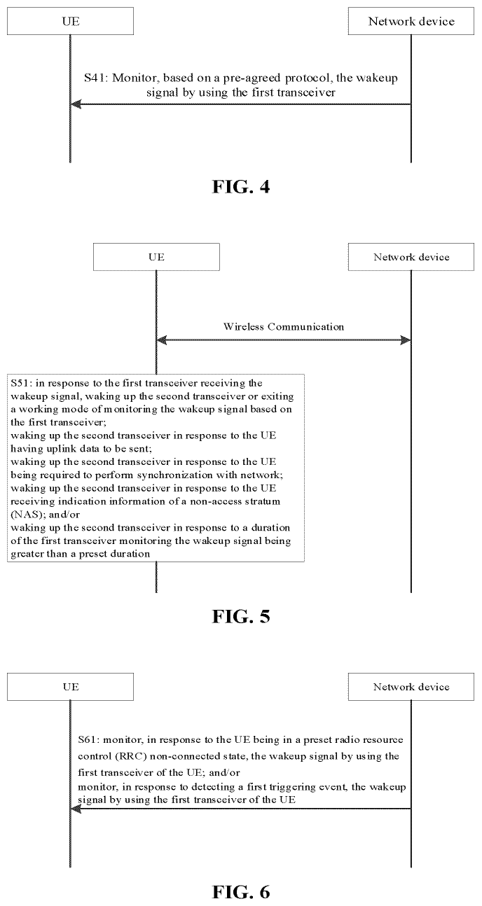

As shown in FIG. 4, some embodiments of this disclosure provide a monitoring method, which is performed by the UE and includes followings.

In step S41, based on the pre-agreed protocol, the wakeup signal is monitored by using the first transceiver.
In some embodiments, the pre-agreed protocol may be a wireless communication protocol. For example, the pre-agreed protocol may be a SG wireless communication standard protocol.

In some other embodiments, the pre-agreed protocol may be a protocol pre-negotiated between the UE and the network device.

This pre-agreed protocol stipulates at least one of the following:
a time-frequency domain position for monitoring the wakeup signal:
scrambling information for monitoring the wakeup signal;
a period for monitoring the wakeup signal;
time offset of a sending time of the wakeup signal relative to a starting time of the period;
a number of times the wakeup signal is sent;
a monitoring mode for monitoring the wakeup signal, where the monitoring mode includes a periodic monitoring mode and/or a continuous monitoring mode.

The pre-agreed protocol is used to stipulate at least one of time-frequency domain information, scrambling information, period information, offset, frequency information (number of times) and monitoring mode information. The time-frequency domain information is used to indicate the time-frequency domain position for monitoring the wakeup signal; the scrambling information is used to indicate the scrambling information for monitoring the wakeup signal; the period information is used to indicate the period for monitoring the wakeup signal; the offset is used to indicate the time offset of the sending time of the wakeup signal relative to the starting time of the period; the frequency information is used to indicate the number of times the wakeup signal is sent; the monitoring mode information is used to indicate the monitoring mode for monitoring the wakeup signal. The time-frequency domain information, scrambling information, period, time offset, number of transmissions and monitoring mode of the wakeup signal agreed in the pre-agreed protocol can be same as or different from the time-frequency domain information, scrambling information, period, time offset, number of transmissions and monitoring mode of the wakeup signal configured by the network device, respectively.

In some embodiments of this disclosure, the UE can monitor the wakeup signal based on the first transceiver in a manner stipulated in the pre-agreed protocol, thereby facilitating unified agreement on the parameters used by the same type of UE to monitor the wakeup signal using the first transceiver.

It should be noted that, those skilled in the art can understand that the methods provided in some embodiments of this disclosure can be implemented alone or together with some methods in other embodiments of this disclosure or some methods in related art.

As shown in FIG. 5, some embodiments of this disclosure provide a monitoring method, which is performed by the UE and may include at least one of followings.

In step S51, in response to the first transceiver receiving the wakeup signal, the second transceiver is woken up or the working mode of monitoring the wakeup signal based on the first transceiver is exited; the second transceiver is woken up in response to the UE having uplink data to be sent; the second transceiver is woken up in response to the UE being required to perform synchronization with network; the second transceiver is woken up in response to the UE receiving indication information of a non-access stratum (NAS); the second transceiver is woken up in response to a duration of the first transceiver monitoring the wakeup signal being greater than a preset duration.

In some embodiments of this disclosure. the first transceiver and the second transceiver may be the first transceiver and the second transceiver in step S21 respectively; and the wakeup signal may be the wakeup signal in step S21.

For example, if the UE receives the wakeup signal based on the first transceiver, it, based on the wakeup signal, wakes up the second transceiver of the UE or exits the working mode of monitoring the wakeup signal based on the first transceiver.

For example, if the UE determines that the UE has uplink data to be sent, it wakes up the second transceiver of the UE. The uplink data may be any kind of service data, or the uplink data may be any kind of information sent by the UE to the network device. For example, if the UE needs to send random access information to the base station, the second transceiver of the UE is woken up.

For example, it may be assumed that the UE is in a synchronized state with the network when using the second transceiver. For example, the UE may maintain a timer. After the timer expires, the UE may be considered to be out of synchronization with the network; at this time, the UE needs to turn on the second transceiver to perform synchronization with the network.

For example, if the UE determines that it needs to perform synchronization with the network, it wakes up the second transceiver of the UE. For example, if the UE determines that it needs to synchronize with the network in the time-frequency domain, it determines to wake up the second transceiver. The time-frequency domain synchronization includes: time synchronization and/or frequency synchronization. In this way, in some scenarios where the UE needs to perform synchronization with the network, such as when it needs to receive GPS signal, the UE can perform synchronization with the network by waking up the second transceiver of the UE.

For example, the UE receives NAS indication information and wakes up the second transceiver of the UE. Here, the NAS indication information may be, but is not limited to, an indication to perform PLMN reselection. The indication information may be any kind of information that can be sent by the NAS. For example, it may be indication information for mobility management, indication information indicating reporting of UE capabilities, or the like.

For example, the UE determines to wake up the second transceiver in response to that a duration from start of monitoring the wakeup signal based on the first transceiver to the current time exceeds a preset duration. Here, the preset duration may be greater than a second duration, and the second duration may be any duration, or may be the period of monitoring the wakeup signal, or may be a preset multiple of the period, or may be at least one DRX cycle. For example, the second duration is 5 seconds. In this way, if the UE monitors the wakeup signal based on the first transceiver for more than the preset duration, the first transceiver may not be able to detect the wakeup signal, or a paging message may be missed if the second transceiver is still not woken up. Accordingly, by waking up the second transceiver, the probability of missing paging message can be reduced and normal communication of the UE can be ensured.

In some embodiments, the preset duration may be preset by the network device.

In some other embodiments, the preset duration may be determined by the UE based on historical data. For example, the UE records at least once a third duration, where the third duration is the difference between the start time when the UE monitors the wakeup signal based on the first transceiver and the time when the UE wakes up the second transceiver. Accordingly, the UE determines the preset duration based on the third duration. Here, the third duration is historical data.

In some embodiments of this disclosure, the UE can wake up the second transceiver by monitoring the wakeup message based on the first transceiver; or the UE can also wake up the second transceiver in response to determining at least one of that it needs to send uplink data, needs to synchronize with the network, receives the NAS indication information, or is in a state where the time for monitoring the wakeup signal based on the first transceiver reaches the second preset duration. In this way, the wakeup of the second transceiver can be triggered in a variety of ways, and can be adapted to more scenarios of how to wake up the second transceiver after the first transceiver is introduced at the UE.

It should be noted that, those skilled in the art can understand that the methods provided in some embodiments of this disclosure can be implemented alone or together with some methods in other embodiments of this disclosure or some methods in related art.

In some embodiments of step S21, monitoring the wakeup signal based on the first transceiver of UE includes at least one of following:
monitoring, in response to the UE being in a preset RRC non-connected state, the wakeup signal by using the first transceiver of the UE:
monitoring, in response to detecting a first triggering event, the wakeup signal by using the first transceiver of the UE.

As shown in FIG. 6, some embodiments of this disclosure provide a monitoring method, which is performed by the UE and includes followings.

In step S61, the wakeup signal is monitored by using the first transceiver of the UE in response to the UE being in a preset RRC non-connected state; and/or, the wakeup signal is monitored by using the first transceiver of the UE in response to detecting a first triggering event.

In some embodiments of this disclosure, the first transceiver is the first transceiver in step S21, and the wakeup signal is the wakeup signal in step S21.

The preset RRC non-connected state may be a newly defined RRC non-connected state. For example, the preset RRC non-connected state of UE is RRC ultra-non-connected state, where the RRC ultra-non-connected state includes: RRC ultra-inactive state (RRC-ultra-INACTIVE) or RRC ultra-idle state (RRC-ultra-IDLE).

The preset RRC non-connected state may be independent of any existing RRC state, or may be a sub-state of an existing RRC state. For example, the RRC ultra-idle state (RRC-ultra-IDLE) may be a sub-state of RRC idle state (RRC-IDLE).

The UE being in the preset RRC non-connected state includes but not limited to one of the following:
the UE being in an RRC ultra-idle state;
the UE being in an RRC ultra-inactive state;
the UE switching from an RRC idle state to the RRC ultra-idle state;
the UE switching from an RRC inactive state to the RRC ultra-inactive state.

Some embodiments of this disclosure provide a monitoring method, which is performed by the UE and includes one of the following:
monitoring, in response to the UE being in the RRC ultra-idle state, the wakeup signal based on the first transceiver;
monitoring, in response to the UE being in the RRC ultra-inactive state, the wakeup signal based on the first transceiver.

For example, if the UE is in the ultra-idle state, the UE monitors the wakeup signal based on the first transceiver of the UE; or, if the UE is in the ultra-inactive state, the UE monitors the wakeup signal based on the first transceiver of the UE. Here, the UE being in the ultra-idle state may include but is not limited to: the UE switching from the RRC connected state to the RRC ultra-idle state, or the UE switching from the RRC idle state to the RRC ultra-idle state, or the like. The UE being in the RRC inactive state may include but is not limited to: the UE switching from the RRC connected state to the RRC inactive state, or the UE switching from the RRC inactive state to the RRC ultra-inactive state.

Some embodiments of this disclosure provide a monitoring method, which is performed by the UE and includes one of the following:
monitoring, in response to the UE switching from the RRC idle state to the RRC ultra-idle state, the wakeup signal based on the first transceiver;
monitoring, in response to the UE switching from the RRC inactive state to the RRC ultra-inactive state, the wakeup signal based on the first transceiver.

For example, if the UE switches from the RRC idle state to the RRC ultra-idle state, the wakeup signal is monitored based on the first transceiver of the UE; or, if the UE switches from the RRC inactive state to the RRC ultra-inactive state, the wakeup signal is monitored based on the first transceiver of the UE.

In this way, according to some embodiments of this disclosure, when the UE is in the RRC ultra non-connected state or switches from the RRC non-connected state to the RRC ultra non-connected state, the UE can monitor the wakeup signal based on the first transceiver, thereby saving the power consumption and battery life of the UE.

The first triggering event includes but is not limited to at least one of the following:
a communication signal strength of the UE being greater than a preset strength;
the UE being located in a central area of a cell where the UE is located;
the UE receiving no downlink data within a first preset duration;
the UE receiving an explicit indication sent by the network device;
a received power of the UE receiving signal is greater than a preset power.

When referring to that the communication signal strength of the UE is greater than the preset strength, it may be that a signal strength of a signal received by the UE is greater than the preset strength.

For example, if the UE detects that the signal strength of the signal received by the UE is greater than the preset strength and/or determines that a position of the UE is in the central area of the cell where the UE is located, then the UE monitors the wakeup signal based on the first transceiver of the UE.

For example, if the UE does not receive downlink data within the first preset duration, the UE may enter a preset RRC non-connected state to reduce the power consumption of the UE.

In this way, according to some embodiments of this disclosure, if the UE detects that the signal strength of the signal received by the UE is greater than the preset strength, it can be determined that the communication quality of the UE is relatively good; and/or if the UE determines that the position of the UE is in the central area of the cell where the UE is located, it can also be determined that the communication quality of the UE will be relatively good. In this way, even if the first transceiver with relatively low power consumption is used to monitor the wakeup signal, the success rate of detecting the wakeup signal can be ensured. Moreover, because the wakeup signal is monitored by using the first transceiver with relatively low power consumption, rather than using the second transceiver with higher power consumption, the power consumption and battery life of the UE can be saved.

In some embodiments of this disclosure, the UE can enter the working mode of monitoring the wakeup signal using the first transceiver in response to switching from the RRC idle state to the RRC ultra-idle state or from the RRC inactive state to the RRC ultra-inactive state, or in response to detecting the first triggering event. In this way, multiple ways are provided for triggering the UE to monitor the wakeup signal by using the first transceiver. thereby being adapted to more application scenarios.

Some embodiments of this disclosure provide a monitoring method, which is performed by the UE and includes at least one of the following:
in response to the UE switching from a preset RRC non-connected state to the RRC non-connected state, waking up the second transceiver or exiting a working mode of monitoring the wakeup signal based on the first transceiver;
in response to detecting a second triggering event, waking up the second transceiver or exiting the working mode of monitoring the wakeup signal based on the first transceiver, where the second triggering event includes that the second transceiver is woken up by the wakeup signal.

When referring to that the UE exits the working mode of monitoring the wakeup signal based on the first transceiver, it may be but is not limited to at least one of the following modes: the UE does not monitor the wakeup signal based on the first transceiver of the UE; and the UE monitors the wakeup signal based on the second transceiver.

In some embodiments, the second triggering event may also be, but is not limited to, at least one of the following events. the UE determines that there is uplink data to be sent, the UE needs to synchronize with the network, the UE receives indication information from the NAS, and the time for the UE to monitor the wakeup signal based on the first transceiver is longer than a preset duration.

Here, when referring to that the UE switches from the preset RRC non-connected state to the RRC non-connected state, it includes one of the following:
the UE switches from the RRC ultra-idle state to the RRC idle state:
the UE switches from the RRC ultra-inactive state to the RRC inactive state.

Some embodiments of this disclosure provide a monitoring method, which is performed by the UE and includes one of the following:
in response to the UE switching from the RRC ultra-idle state to the RRC idle state, waking up the second transceiver or exiting the working mode of monitoring the wakeup signal based on the first transceiver;
in response to the UE switching from the RRC ultra-inactive state to the RRC inactive state, waking up the second transceiver or exiting the working mode of monitoring the wakeup signal based on the first transceiver.

In some embodiments of this disclosure, the UE may wake up the second transceiver or exit the working mode of monitoring the wakeup signal using the first transceiver in response to switching from the RRC ultra-idle state to the RRC idle state or from the RRC ultra-inactive state to the RRC inactive state, or in response to detecting the second triggering event. In this way, according to some embodiments of this disclosure, the UE is enabled to autonomously exit the working mode of monitoring the wakeup signal using the first transceiver, thereby facilitating the UE to cope with the complex wireless communication network environment. The embodiments of this disclosure provide multiple ways for exiting the mode of monitoring the wakeup signal based on the first transceiver, thereby being adapted to more application scenarios.

Some embodiments of this disclosure provide a monitoring method, which is performed by the UE and includes at least one of the following:
in response to the UE exiting the working mode of monitoring the wakeup signal based on the first transceiver, performing synchronization with the network based on the second transceiver;
in response to the UE exiting the working mode of monitoring the wakeup signal based on the first transceiver, receiving a system message based on the second transceiver.

The network synchronization includes but is not limited to at least one of the following: time synchronization and/or frequency synchronization.

Here, after receiving the system message, the UE can also update the system message stored in the UE based on the received system message.

Some embodiments of this disclosure provide a monitoring method, which performed by the UE and includes but not limited to at least one of the following:
in response to the UE exiting the working mode of monitoring the wakeup signal ba1sed on the first transceiver, monitoring a paging message based on the second transceiver;

in response to the UE exiting the working mode of monitoring the wakeup signal based on the first transceiver, performing cell measurement based on the second transceiver:
in response to the UE exiting the working mode of monitoring the wakeup signal based on the first transceiver, performing cell selection or cell reselection or PLMN reselection based on the second transceiver.

In this way, according to some embodiments of this disclosure, after the UE exits the working mode of monitoring the wakeup signal based on the first transceiver, it can enter the RRC connected state working mode of synchronizing with the network and/or receiving the system message based on the second transceiver, or enter the RRC non-connected state working mode of monitoring the paging message based on the second transceiver. In this way, working states of the UE after the UE exits the working mode of monitoring the wakeup signal based on the first transceiver are defined.

It should be noted that, those skilled in the art can understand that the methods provided in some embodiments of this disclosure can be implemented alone or together with some methods in other embodiments of this disclosure or some methods in related art.

The following monitoring method(s) is performed by network device and is similar to the forgoing description of the monitoring method performed by UE. For those technical details not disclosed in the embodiments of the monitoring method performed by the base station, the exemplary description of the monitoring method performed by UE can be referred to and will not be described in detail here.

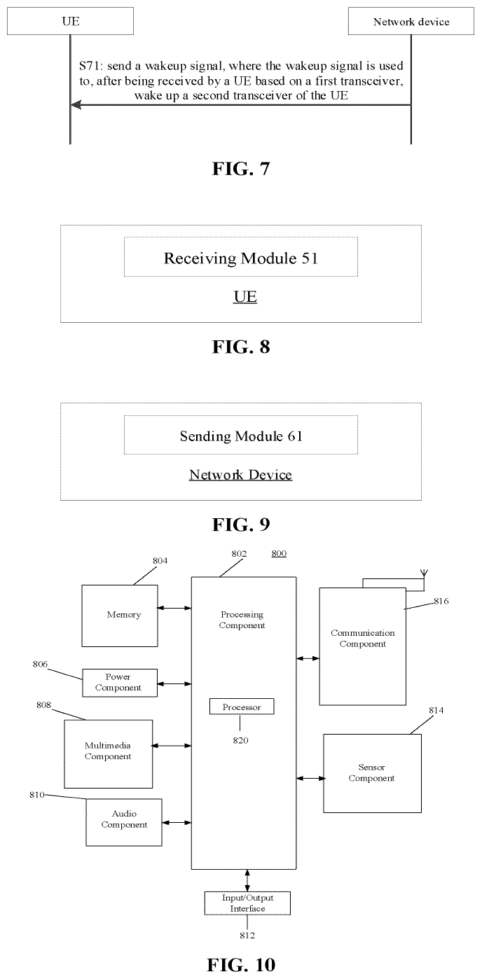

As shown in FIG. 7, some embodiments of this disclosure provide a monitoring method, which is performed by a network device and includes followings.

In step S71, a wakeup signal is sent, where the wakeup signal is used to, after being received by a UE based on a first transceiver, wake up a second transceiver of the UE.

In some embodiments of this disclosure, the first transceiver and the second transceiver are respectively the first transceiver and the second transceiver in step S21, and the wakeup signal is the wakeup signal in step S21.

Here, the awakened second transceiver is configured to monitor a paging message(s).

Here, a power consumption of the first transceiver is less than a power consumption of the second transceiver.

In some embodiments, sending the wakeup signal in step S71 may include: sending the wakeup signal to the UE.

In some other embodiments, sending the wakeup signal in step S71 may include: sending the wakeup signal to at least some UEs in a cell. Here, the wakeup signal is used to wake up the second transceivers of the at least some UEs in the cell.

Some embodiments of this disclosure provide a monitoring method, which is performed by a network device and includes: sending configuration information, where the configuration information is used by the UE to monitor the wakeup signal based on the first transceiver.

The configuration information includes at least one of the following:
time-frequency domain information, used to indicate a time-frequency domain position for monitoring the wakeup signal;
codeword information, used to indicate scrambling information for monitoring the wakeup signal;
period information, used to indicate a period for monitoring the wakeup signal;
offset, used to indicate a time offset of a sending time of the wakeup signal relative to a starting time of the period;
times information, used to indicate a number of times the wakeup signal is sent:
monitoring mode information, used to indicate a monitoring mode for monitoring the wakeup signal. where the monitoring mode includes a periodic monitoring mode and/or a continuous monitoring mode.

Some embodiments of this disclosure provide a monitoring method, which is performed by a network device and includes: sending the configuration information to at least some UEs in a cell.

For a specific description on the network device side, reference may be made to the description on the UE side, which will not be repeated here.

It should be noted, those skilled in the art can understand that the methods according to some embodiments of this disclosure may be implemented alone or together with some methods according to other embodiments of this disclosure or some methods in related art.

In order to further explain some embodiments of this disclosure, a specific example is provided below.

Some embodiments of this disclosure provide a monitoring method, including

the following steps.

In step S81, the UE in the RRC non-connected state monitors the wakeup signal based on the first transceiver of the UE, where the wakeup signal is used to wake up the second transceiver of the UE.

Here, the wakeup signal can be used to wake up at least some UEs in a cell.

In step S82A, the UE in the RRC non-connected state may monitor the wakeup signal by using the first transceiver based on one of the following configurations: monitoring the wakeup signal by using the first transceiver based on the continuous monitoring mode;
monitoring the wakeup signal by using the first transceiver based on the periodic monitoring mode;
monitoring the wakeup signal by using the first transceiver based on the configuration information configured by the network device, where the configuration information includes at least one of the following: period information indicating the period of
monitoring the wakeup signal. an offset indicating the time offset of the sending timepoint of the wakeup signal relative to the starting timepoint of the period, times information indicating the number of times of sending the wakeup signal, and monitoring mode information indicating the monitoring mode of monitoring the wakeup signal;
monitoring the wakeup signal by using the first transceiver based on a pre-agreed protocol, where the pre-agreed protocol stipulates at least one of: a period for monitoring the wakeup signal, time offset of a sending time of the wakeup signal relative to a starting time of the period, a number of times the wakeup signal is sent, a monitoring mode for monitoring the wakeup signal.

Step S82B includes: step S82B1 or step S82B2.

In step S82B1, when the UE in the RRC non-connected state monitors the wakeup signal based on the first transceiver, the second transceiver is in a fully-off state. When the second transceiver is in the fully-off state, it stops at least one of the following behaviors of AS:
performing cell selection and/or reselection;
performing PLMN reselection;
monitoring paging;
monitoring system message:
performing measurement.

In step S82B2, when the UE in the RRC non-connected state monitors the wakeup signal based on the first transceiver, the second transceiver is in a partially-off state. When the second transceiver is in the partially-off state, it maintains part of the behaviors of AS, and the maintained part of the behaviors of AS include at least one of the following:
performing measurement relaxation on the cell where the UE is located and/or a neighboring cell(s);
stopping measurement on the cell where the UE is located and/or a neighboring cell(s).

In step S83, the UE in the RRC non-connected state may wake up the second transceiver based on at least one of the following:
in response to the first transceiver receiving the wakeup signal, waking up the second transceiver or exiting the working mode of monitoring the wakeup signal based on the first transceiver;
waking up the second transceiver in response to the UE having uplink data to be sent;
waking up the second transceiver in response to the UE being required to perform synchronization with network;
waking up the second transceiver in response to the UE receiving indication information of NAS; and
waking up the second transceiver in response to a duration of the first

In some embodiments, the indication information may be used to indicate PLMN reselection.

In step S84, the UE in the RRC non-connected state enters a mode of monitoring the wakeup signal based on the first transceiver, including at least one of the following:
in response to the UE switching from the RRC idle state to the RRC ultra-idle state, monitoring the wakeup signal based on the first transceiver;
in response to the UE switching from the RRC inactive state to the RRC ultra-inactive state, monitoring the wakeup signal based on the first transceiver;
in response to the UE detecting the first triggering event, monitoring the wakeup signal based on the first transceiver, where the first triggering event includes that a communication signal strength of the UE is greater than a preset strength and/or the UE is in a central area of a cell where the UE is located.

In step S85, the UE in the RRC non-connected state exits the mode of monitoring the wakeup signal using the first transceiver, including at least one of the following:
in response to the UE switching from the RRC ultra-idle state to the RRC idle state, exiting the working mode of monitoring the wakeup signal based on the first transceiver;
in response to the UE switching from the RRC ultra-inactive state to the RRC inactive state, exiting the working mode of monitoring the wakeup signal based on the first transceiver;
in response to the UE detecting the second triggering event, exiting the working mode of monitoring the wakeup signal based on the first transceiver, where the second triggering event includes that the second transceiver is woken up by the wakeup signal.

In step S86, in response to the UE exiting the working mode of monitoring thewakeup signal based on the first transceiver, the method further includes at least one of the following:
performing synchronization with the network based on the second transceiver;
receiving system messages based on the second transceiver.

It should be noted that, those skilled in the art can understand that the methods provided in some embodiments of this disclosure can be implemented alone or together with some methods in other embodiments of this disclosure or some methods in related art.

As shown in FIG. 8, some embodiments of this disclosure provide a monitoring apparatus, which is applied to UE and includes:
a receiving module 51, configured to monitor a wakeup signal based on a first transceiver of the UE, where the wakeup signal is used to wake up a second transceiver of the UE.

Here, the awakened second transceiver is configured to monitor a paging message(s).

Here, a power consumption of the first transceiver is less than a power consumption of the second transceiver.

Some embodiments of this disclosure provide a monitoring apparatus, which is applied to UE and includes: the receiving module 51, configured to monitor the wakeup signal sent by a network device based on the first transceiver of the UE.

Some embodiments of this disclosure provide a monitoring apparatus, which is applied to UE and includes: the receiving module 51, configured to receive configuration information.

The receiving module 51 is configured to monitor the wakeup signal by using the first transceiver based on the configuration information.

In some embodiments, the configuration information includes but is not limited to at least one of the following:
time-frequency domain information, used to indicate a time-frequency domain position for monitoring the wakeup signal;
codeword information, used to indicate scrambling information for monitoring the wakeup signal;
period information, used to indicate a period for monitoring the wakeup signal; offset, used to indicate a time offset of a sending time of the wakeup signal relative to a starting time of the period;
times information, used to indicate a number of times the wakeup signal is sent;
monitoring mode information, used to indicate a monitoring mode for monitoring the wakeup signal, where the monitoring mode includes a periodic monitoring mode and/or a continuous monitoring mode.

Some embodiments of this disclosure provide a monitoring apparatus, which is applied to UE and includes: the receiving module 51, configured to monitor the wakeup signal by using a first transceiver based on a pre-agreed protocol.

In some embodiments, the pre-agreed protocol stipulates at least one of the following:
a time-frequency domain position for monitoring the wakeup signal;
scrambling information for monitoring the wakeup signal;
a period for monitoring the wakeup signal;
time offset of a sending time of the wakeup signal relative to a starting time of the period;
a number of times the wakeup signal is sent;
a monitoring mode for monitoring the wakeup signal, where the monitoring mode includes a periodic monitoring mode and/or a continuous monitoring mode.

In some embodiments, when the first transceiver monitors the wakeup signal, the second transceiver is in a first off state or in a second off state; where the second transceiver in the first off state is configured to stop all behaviors of the AS, and the second transceiver in the second off state is configured to maintain some behaviors of the AS.

In some embodiments, the second transceiver in the first off state is configured to select, but is not limited to, at least one of the following:
performing PLMN reselection;
performing monitoring of paging;
not performing monitoring of system message;
not performing cell measurement.

In some embodiments, the second transceiver in the second off state is configured to select, but is not limited to, at least one of the following:
performing measurement relaxation on a neighboring cell and/or a cell where the UE is located;
stopping measurement on the neighboring cell and/or the cell where the UE is located.

Some embodiments of this disclosure provide a monitoring apparatus, which is applied to UE and includes: a processing module, configured to, in response to receiving the wakeup signal based on the first transceiver, wake up the second transceiver or exit the working mode of monitoring the wakeup signal based on the first transceiver.

Some embodiments of this disclosure provide a monitoring apparatus, which is applied to UE and includes: a processing module, configured to wake up the second transceiver in response to the UE having uplink data to be sent.

Some embodiments of this disclosure provide a monitoring apparatus, which is applied to UE and includes: a processing module, configured to wake up the second transceiver in response to the UE being required to perform synchronization with the network.

Some embodiments of this disclosure provide a monitoring apparatus, which is applied to UE and includes: a processing module, configured to wake up the second transceiver in response to the UE receiving indication information from NAS. In some embodiments, the indication information may be used to indicate PLMN reselection.

Some embodiments of this disclosure provide a monitoring apparatus, which is applied to UE and includes: a processing module, configured to wake up the second transceiver in response to the time for the first transceiver to monitor the wakeup signal being greater than a preset duration.

Some embodiments of this disclosure provide a monitoring apparatus, which is applied to UE and includes: a processing module, configured to monitor the wakeup signal by using the first transceiver of the UE in response to the UE being in a preset RRC non-connected state.

In some embodiments, the UE being in the preset RRC non-connected state includes one of the following:
the UE being in the RRC ultra-idle state:
the UE being in the RRC ultra-inactive state:
the UE switching from the RRC idle state to the RRC ultra-idle state:
the UE switching from the RRC inactive state to the RRC ultra-inactive state.

Some embodiments of this disclosure provide a monitoring apparatus, which is applied to UE and includes: a processing module, configured to monitor the wakeup signal by using the first transceiver of the UE in response to the UE switching from the RRC idle state to the RRC ultra-idle state.

Some embodiments of this disclosure provide a monitoring apparatus, which is applied to UE and includes: a processing module, configured to monitor the wakeup signal by using the first transceiver of the UE in response to the UE switching from the RRC inactive state to the RRC ultra-inactive state.

Some embodiments of this disclosure provide a monitoring apparatus, which is applied to UE and includes: a processing module, configured to monitor the wakeup signal by using the first transceiver of the UE in response to detecting a first triggering event.

In some embodiments, the first triggering event includes at least one of:
a communication signal strength of the UE being greater than a preset strength;
the UE being located in a central area of a cell where the UE is located;
the UE receiving no downlink data within a first preset duration.

Some embodiments of this disclosure provide a monitoring apparatus, which is applied to UE and includes: a processing module, configured to, in response to the UE switching from a preset RRC non-connected state to the RRC non-connected state, wake up the second transceiver or exit the working mode of monitoring the wakeup signal based on the first transceiver.

Some embodiments of this disclosure provide a monitoring apparatus, which is applied to UE and includes: a processing module, configured to exit the working mode of monitoring the wakeup signal based on the first transceiver in response to the UE switching from the RRC ultra-idle state to the RRC idle state.

Some embodiments of this disclosure provide a monitoring apparatus, which is applied to UE and includes: a processing module, configured to exit the working mode of monitoring the wakeup signal based on the first transceiver in response to the UE switching from the RRC ultra-inactive state to the RRC inactive state.

Some embodiments of this disclosure provide a monitoring apparatus, which is applied to UE and includes: a processing module, configured to exit the working mode of monitoring the wakeup signal based on the first transceiver in response to detecting a second triggering event, where the second triggering event includes that the second transceiver is woken up by the wakeup signal.

Some embodiments of this disclosure provide a monitoring apparatus, which is applied to UE and includes: a processing module, configured to perform synchronization with the network based on the second transceiver in response to the UE exiting the working mode of monitoring the wakeup signal based on the first transceiver.

Some embodiments of this disclosure provide a monitoring apparatus, which is applied to UE and includes: a processing module, configured to receive a system message(s) based on the second transceiver in response to the UE exiting the working mode of monitoring the wakeup signal based on the first transceiver.

As shown in FIG. 9, some embodiments of this disclosure provide a monitoring apparatus, which is applied to the network device and includes:
a sending module 61, configured to send a wakeup signal, where the wakeup signal is used to, after being received by UE based on a first transceiver, wake up a second transceiver of the UE.

Here, the awakened second transceiver is configured to monitor a paging message(s).

Here, a power consumption of the first transceiver is less than a power consumption of the second transceiver.

Some embodiments of this disclosure provide a monitoring apparatus, which is applied to the network device and includes: the sending module 61 configured to send the wakeup signal to at least some UEs in a cell.

Some embodiments of this disclosure provide a monitoring apparatus, which is applied to the network device and includes: the sending module 61 configured to send configuration information, where the configuration information is used for the UE to monitor the wakeup signal based on the first transceiver.

In some embodiments, the configuration information includes but is not limited to at least one of the following:
time-frequency domain information, used to indicate a time-frequency domain position for monitoring the wakeup signal;
codeword information, used to indicate scrambling information for monitoring the wakeup signal;
period information, used to indicate a period for monitoring the wakeup signal;
offset, used to indicate a time offset of a sending time of the wakeup signal relative to a starting time of the period;
times information, used to indicate a number of times the wakeup signal is sent;
monitoring mode information, used to indicate a monitoring mode for monitoring the wakeup signal, where the monitoring mode includes a periodic monitoring mode and/or a continuous monitoring mode.

It should be noted that, those skilled in the art can understand that the apparatuses provided in some embodiments of this disclosure can be implemented alone or together with some apparatuses in other embodiments of this disclosure or some apparatuses in related art.

Regarding the apparatuses in the above embodiments, the specific manner in which each module performs operations has been described in detail in the embodiments related to the methods, and will not be described in detail here.

Some embodiments of this disclosure provide a communication device, including:
a memory configured to store instructions executable by the processor;
where the processor is configured to, upon running the executable instructions, implement the monitoring method according to any embodiment of this disclosure.

In some embodiments, the communication device may include, but is not limited to, at least one of: a base station or a UE.

The processor may include various types of storage medium, which are non-transitory computer storage medium that can continue to memorize the information stored thereon after the UE is powered off.

The processor may be connected to the memory through a bus or the like, and configured to read the executable program stored on the memory, for example, at least one of the methods shown in FIG. 2 to FIG. 7.

Some embodiments of this disclosure further provide a computer storage medium. The computer storage medium stores a computer executable program. When the executable program is executed by a processor, the monitoring method according to any embodiment of this disclosure is implemented. For example, at least one of the methods shown in FIG. 2 to FIG. 7 is implemented.

Regarding the device or storage medium in the above embodiments, the specific manner in which each module performs operations has been described in detail in the embodiments related to the method, and will not be described in detail here.

FIG. 10 is a block diagram showing a UE 800 according to some embodiments. For example, the UE 800 may be a mobile phone, a computer, a digital broadcast terminal, a messaging device, a game console, a tablet device, a medical device, a fitness device, a personal digital assistant, and the like.

Referring to FIG. 10, the UE 800 may include one or more of the following components: processing component 802, memory 804, power component 806, multimedia component 808, audio component 810, input/output (I/O) interface 812, sensor component 814, and communication component 816.

The processing component 802 generally controls the overall operation of the UE 800, such as operations associated with display, phone calls, data communications, camera operations, and recording operations. The processing component 802 may include one or more processors 820 to execute instructions to perform all or some of the steps of the methods described above. Additionally, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support operation at the UE 800. Examples of such data include instructions, contact data, phonebook data, messages, pictures, videos, and the like for any application or method operating on the UE 800. The memory 804 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 806 provides power to various components of the UE 800. The power components 806 may include a power management system, one or more power sources, and other components associated with generating, managing, and distributing power to the UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 808 includes a front camera and/or a rear camera. When the UE 800 is in an operation mode, such as a shooting mode or a video mode, the front camera and/or the rear camera may receive external multimedia data. Each of the front and rear cameras may be a fixed optical lens system or have focal length and optical zoom capability.

The audio component 810 is configured to output and/or input audio signals. For example, the audio component 810 includes a microphone (MIC) that is configured to receive external audio signals when the UE 800 is in operating modes, such as calling mode, recording mode, and voice recognition mode. The received audio signal may be further stored in the memory 804 or transmitted via the communication component 816. In some embodiments, the audio component 810 also includes a speaker for outputting audio signals.

The I/O interface 812 provides an interface between the processing component 802 and a peripheral interface module, which may be a keyboard, a click wheel, a button, or the like. These buttons may include, but are not limited to: home button, volume buttons, start button, and lock button.

The sensor assembly 814 includes one or more sensors for providing status assessments of various aspects of the UE 800. For example, the sensor assembly 814 can detect the open/closed state of the UE 800, the relative positioning of components, such as the display and keypad of the UE 800. The sensor assembly 814 can also detect a change in the position of the UE 800 or a component of the UE 800, the presence or absence of user contact with the UE 800, the orientation or acceleration/deceleration of the UE 800, and the temperature change of the UE 800. The sensor assembly 814 may include a proximity sensor configured to detect the presence of nearby objects in the absence of any physical contact. The sensor assembly 814 may also include a light sensor, such as a CMOS or CCD image sensor, for use in imaging applications. In some embodiments, the sensor assembly 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access wireless networks based on communication standards, such as WiFi, 4G or 5G, or a combination thereof. In some embodiments, the communication component 816 receives broadcast signals or broadcast related information from an external broadcast management system via a broadcast channel. In some embodiments, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the UE 800 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the forgoing methods.

In some embodiments, there is also provided a non-transitory computer-readable storage medium including instructions, such as the memory 804 including instructions, executable by the processor 820 of the UE 800 to perform the method described above. For example, the non-transitory computer-readable storage medium may be ROM, random access memory (RAM), CD-ROM, magnetic tape, floppy disk, optical data storage device, and the like.

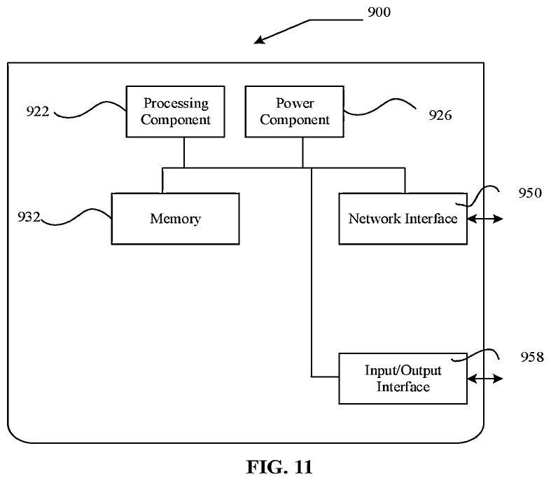

As shown in FIG. 11, it shows a structure of a base station according to some embodiments. For example, the base station 900 may be provided as a network device. Referring to FIG. 11, the base station 900 includes a processing component 922, which further includes one or more processors; and a memory resource represented by memory 932 for storing instructions executable by the processing component 922, such as application programs. The application program stored in memory 932 may include one or more modules each corresponding to a set of instructions. In addition, the processing component 922 is configured to execute instructions to perform the forgoing methods.

The base station 900 may also include a power component 926 configured to perform power management of the base station 900, a wired or wireless network interface 950 configured to connect the base station 900 to a network, and an input-output (I/O)) interface 958. The base station 900 can operate based on an operating system stored in the memory 932, such as Windows Server™, Mac OS X™, Unix™, Linux™, FreeBSD™ or the like.

Other embodiments of this disclosure will be readily apparent to those skilled in the art from consideration of the specification and practice of the invention disclosed herein. This application is intended to cover any modification, use or adaptation of this disclosure, and these modifications. uses or adaptations follow the general principles of this disclosure and include common knowledge or conventional technical means in the art, which are not disclosed in this disclosure. The specification and examples are to be considered exemplary only, with a true scope and spirit of the disclosure being indicated by the following claims.

It should be understood that this disclosure is not limited to the precise constructions which have been described above and shown in the drawings, and various modifications and changes may be made without departing from the scope thereof. The scope of this disclosure is limited only by the scope of the appended claims.

1. A monitoring method, performed by a user equipment (UE), comprising:
monitoring a wakeup signal based on a first transceiver of the UE, wherein the wakeup signal is used to wake up a second transceiver of the UE.

2. The monitoring method according to claim 1, further comprising:
receiving configuration information; and
wherein monitoring the wakeup signal based on the first transceiver of the UE comprises:
monitoring, based on the configuration information, the wakeup signal by using the first transceiver.

3. The monitoring method according to claim 2, wherein the configuration information comprises at least one of:
time-frequency domain information, indicating a time-frequency domain position for monitoring the wakeup signal;
codeword information, indicating scrambling information for monitoring the wakeup signal;
period information, indicating a period for monitoring the wakeup signal;
offset, indicating a time offset of a sending time of the wakeup signal relative to a starting time of the period;
times information, indicating a number of times the wakeup signal is sent; or
monitoring mode information, indicating a monitoring mode for monitoring the wakeup signal, wherein the monitoring mode comprises a periodic monitoring mode or a continuous monitoring mode.

4. The monitoring method according to claim 1, wherein monitoring the wakeup signal based on the first transceiver of the UE comprises:
monitoring, based on a pre-agreed protocol, the wakeup signal by using the first transceiver.

5. The monitoring method according to claim 4, wherein the pre-agreed protocol stipulates at least one of:
a time-frequency domain position for monitoring the wakeup signal;
scrambling information for monitoring the wakeup signal;
a period for monitoring the wakeup signal;
time offset of a sending time of the wakeup signal relative to a starting time of the period;
a number of times the wakeup signal is sent; or
a monitoring mode for monitoring the wakeup signal, wherein the monitoring mode comprises a periodic monitoring mode or a continuous monitoring mode.

6. The monitoring method according to any one according to claim 1,
the second transceiver is in a first off state or a second off state when the first transceiver monitors the wakeup signal,
the second transceiver in the first off state is configured to stop all behaviors of an access stratum (AS), and
the second transceiver in the second off state is configured to maintain part of the behaviors of the AS.

7. The monitoring method according to claim 6, wherein the second transceiver in the first off state is configured to select at least one of:
not performing cell selection or reselection:
not performing reselection of public land mobile network (PLMN);
not performing monitoring of paging;
not performing monitoring of system message; or not performing cell measurement.

8. The monitoring method according to claim 6, wherein the second transceiver in the second off state is configured to select at least one of:
performing measurement relaxation on at least one of a neighboring cell or a cell where the UE is located; or
stopping measurement on at least one of the neighboring cell or and/or-the cell where the UE is located;

9. The monitoring method according to claim 1, further comprising:
in response to the first transceiver receiving the wakeup signal, waking up the second transceiver or exiting a working mode of monitoring the wakeup signal based on the first transceiver;
waking up the second transceiver in response to the UE having uplink data to be sent;
waking up the second transceiver in response to the UE being required to perform synchronization with network;
waking up the second transceiver in response to the UE receiving indication information of a non-access stratum (NAS); or
waking up the second transceiver in response to a duration of the first transceiver monitoring the wakeup signal being greater than a preset duration.

10. The monitoring method according to claim 1, wherein monitoring the wakeup signal based on the first transceiver of the UE comprises at least one of:
monitoring, in response to the UE being in a preset radio resource control (RRC) non-connected state, the wakeup signal by using the first transceiver of the UE; or
monitoring, in response to detecting a first triggering event, the wakeup signal by using the first transceiver of the UE.

11. The monitoring method according to claim 10, wherein the UE being in the preset RRC non-connected state comprises one of:
the UE being in an RRC ultra-idle state; or
the UE being in an RRC ultra-inactive state.

12. The monitoring method according to claim 10, wherein the first triggering event comprises at least one of:
a communication signal strength of the UE being greater than a preset strength;
the UE being located in a central area of a cell where the UE is located;
the UE receiving no downlink data within a first preset duration;
the UE switching from an RRC idle state to the RRC ultra-idle state; or
the UE switching from an RRC inactive state to the RRC ultra-inactive state.

13. The monitoring method according to claim 10, further comprising:
in response to the UE switching from the preset RRC non-connected state to a second RRC non-connected state, waking up the second transceiver or exiting a working mode of monitoring the wakeup signal based on the first transceiver.

14. The monitoring method according to claim 13, wherein the UE switching from the preset RRC non-connected state to the second RRC non-connected state comprises one of:
the UE switching from an RRC ultra-idle state to an RRC idle state; or
the UE switching from an RRC ultra-inactive state to an RRC inactive state.

15. The monitoring method according to claim 9, further comprising at least one of:
performing the synchronization with the network based on the second transceiver; or
receiving a system message based on the second transceiver.

16. A monitoring method, performed by a network device, comprising:
sending a wakeup signal, wherein the wakeup signal is used to, after being received by a user equipment (UE) based on a first transceiver, wake up a second transceiver of the UE.

17. The monitoring method according to claim 16, further comprising;
sending configuration information, wherein the configuration information is used by the UE to monitor the wakeup signal based on the first transceiver.

18. The monitoring method according to claim 17, wherein the configuration information comprises at least one of:
time-frequency domain information, indicating a time-frequency domain position for monitoring the wakeup signal;
codeword information, indicating scrambling information for monitoring the wakeup signal;
period information, indicating a period for monitoring the wakeup signal;
offset, indicating a time offset of a sending time of the wakeup signal relative to a starting time of the period;
times information, indicating a number of times the wakeup signal is sent; or
monitoring mode information, indicating a monitoring mode for monitoring the wakeup signal, wherein the monitoring mode comprises a periodic monitoring mode and/or a continuous monitoring mode.

19-21. (canceled)

22. A user equipment (UA), comprising:
a processor; and
a memory storing instructions executable by
wherein the processor is configured to:
monitor a wakeup signal based on a first transceiver of the UE, wherein the wakeup signal is used to wake up a second transceiver of the UE

23. (canceled)

24. A network device, comprising:
a processor; and
a memory storing instructions executable by the processor,
wherein the processor is configured to, upon executing the instructions, implement the monitoring method according to claim 16.
